(19) United States
(12) Patent Application Publication
(10) Pub. No.: US 2010/0091690 A1
(43) Pub. Date: Apr. 15, 2010

(54) DISTRIBUTION DIPLEXER

(75) Inventor: Kevin R. Boyle, West Sussex (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/720,836

(22) PCT Filed: Nov. 30, 2005
(86) PCT No.: PCT/IB2005/053984

§ 371 Date: Dec. 22, 2009

(30) Foreign Application Priority Data
Dec. 2, 2004 (GB) 0426443.8

(51) Int. Cl. H04L 5/00

(52) U.S. Cl. 370/297

(57) ABSTRACT

A multi-band RF circuit has receive paths for two or more bands, and transmit paths, a bidirectional one-in multi-le-out transmission line junction (100) for combining the paths for coupling to an antenna. A switch combines transmit and receive paths, and a receive path circuit (110, 150, 160, 230, 240) is arranged to pass signals of its band, and appear open circuit to signals of the other bands. This means the combiner no longer needs to cut off the receive paths when they are not used. This can reduce components and thus reduce losses in the transmit paths for longer battery life or greater transmit range. A band filter (SAW) and a complementary circuit can achieve the open circuit. The bands can include GSM and GPS bands, the circuits can be used in tri band mobile handsets and handsets for future 3G bands, or base stations.

This invention relates to multi band RF circuits, to apparatus having such a circuit coupled to an antenna, and to mobile devices or fixed base stations having such circuits.

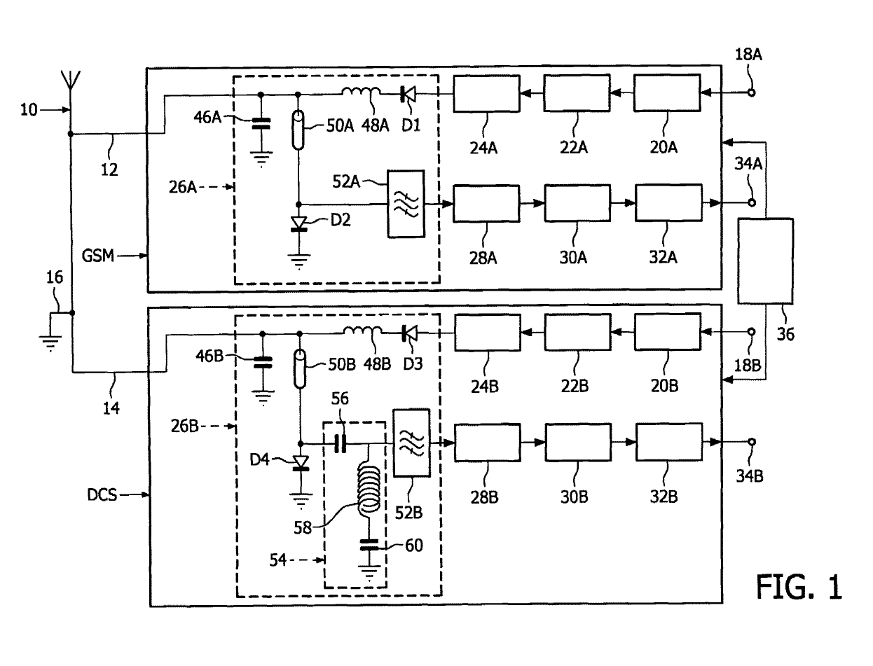

It is known to provide an RF circuit for a handset for use with multiple bands, usually two or three bands. A diplexer (also called a duplexer or multiplexer) is used to couple the RF circuitry for separate bands with the antenna. This effectively switches one or more of the transmit paths to the antenna, and separates the receive paths from the antenna. As shown in FIG. 1, a switch is provided for each band, to separate the transmit and receive paths. This diplexer is usually made up of passive components and causes some power loss in the transmit path. There are also losses caused by the need to share an antenna and a matching circuit between two or more bands, meaning these parts cannot be optimised for either band.

It is known from WO 03094346 to provide an antenna with two feeds from the RF circuitry, so that better matching can be obtained for each band and hence increased bandwidth. This can lead to smaller antenna sizes, which is useful for applications such as mobile handsets. However the circuit is more complex to manufacture, since the layout of the metal of the lines and antenna couplings needs careful design and typically will have small tolerances. Capacitors need to be carefully matched and again have low tolerances. Also the arrangement is less modular, as the interface with the RF circuitry is no longer a standard interface, so there is less flexibility or choice of different modules.

It is also known from U.S. Pat. No. 6,714,766 to provide a passive network to replace diode switches to connect or disconnect either a transmitter or a receiver to an antenna. A filter having symmetrical ports acts to connect either the transmitter or the receiver to ground and connect the other to the antenna.

There remains a need for improved circuits.

It is an object of the invention to provide improved apparatus or methods. According to a first aspect of the invention, there is provided:

A multi-band RF circuit having receive paths for two or more bands, and transmit paths for at least one of the bands, a combiner circuit for combining the paths for coupling to an antenna, and a receive path circuit in each of the receive paths for each band before the combiner circuit, arranged to pass signals of its band, and appear open circuit to signals of the other bands.

This helps enable the combiner circuit to be simplified since it no longer needs to cut off the receive paths when they are not used. This can have the effect of enabling the transmit paths to have fewer components, or lower specification components with more unwanted leakage to the receive paths for example. Fewer components in the transmit paths is notable for enabling is transmit losses to be reduced, which can lead to notable advantages such as longer battery life in mobile applications or greater transmit range for a given power amplifier for example. Typically these advantages outweigh additional costs of more components and more losses in the receive paths. In many cases there are no more components or losses in the receive path, where a conventional diplexer (in both the TX and RX paths) has notionally been split in half and put in the RX paths only.

An additional feature for a dependent claim is the combiner circuit having a fixed bidirectional one-in multiple-out junction to couple together paths of two or more of the bands. This is one way to exploit the open circuit feature, to replace some of the switching or diplexing circuitry so that transmission losses in the transmit paths can be reduced, to increase battery life or range as discussed above.

Another additional feature is the receive path circuit having a band filter and a complementary circuit to complement the out of band impedance of the band filter to achieve the open circuit. This can help reduce the amount of circuitry, and can enable a better open circuit characteristic and reduce transmission losses.

Another such additional feature is the combiner circuit comprising a transmission line junction for combining paths of different bands. This is preferred to alternatives such as passive components or switches as there are no component losses. Alternatives may be needed if there is insufficient gap between the bands.

Another such additional feature is a switch to combine transmit and receive paths for each band. This is useful where there is little gap between transmit and receive frequencies.

Another such additional feature is each complementary circuit comprising passive components to maintain a characteristic impedance to in band signals, and to contribute to the open circuit to out of band signals. Such passive components can typically be made smaller than alternatives such as transmission line elements, which is useful for applications such as mobile handsets.

Another such additional feature is the band filter comprising an acoustic wave filter. Such filters typically have a characteristic which shows an impedance out of band which is predominantly reflective (usually capacitive and slightly resistive), which can contribute to an overall open circuit characteristic.

Another such additional feature is two bands and two receive paths. This is useful for applications such as GSM radio, or mobile radio and GPS bands.

Another such additional feature is a third band arranged to share a transmit path with another of the bands and having a separate receive path.

Another such additional feature is a second transmission line junction for combining the receive path of the third band with the receive path of another of the bands before the combiner circuit. This could be useful for applications such as tri band mobile handsets and handsets for future 3G bands.

Another aspect provides apparatus having the multi band RF circuit coupled to a single input antenna matching circuit and an antenna.

Another aspect provides a mobile battery powered device having the apparatus.

Another aspect provides a fixed base station having the apparatus.

Any of the additional features can be combined together or with any of the aspects of the invention, as would be apparent to those skilled in the art. Other advantages may be apparent to those skilled in the art, especially over other prior art not known to the inventors.

Embodiments of the invention will now be described by way of example, and with reference to the accompanying drawings, in which:

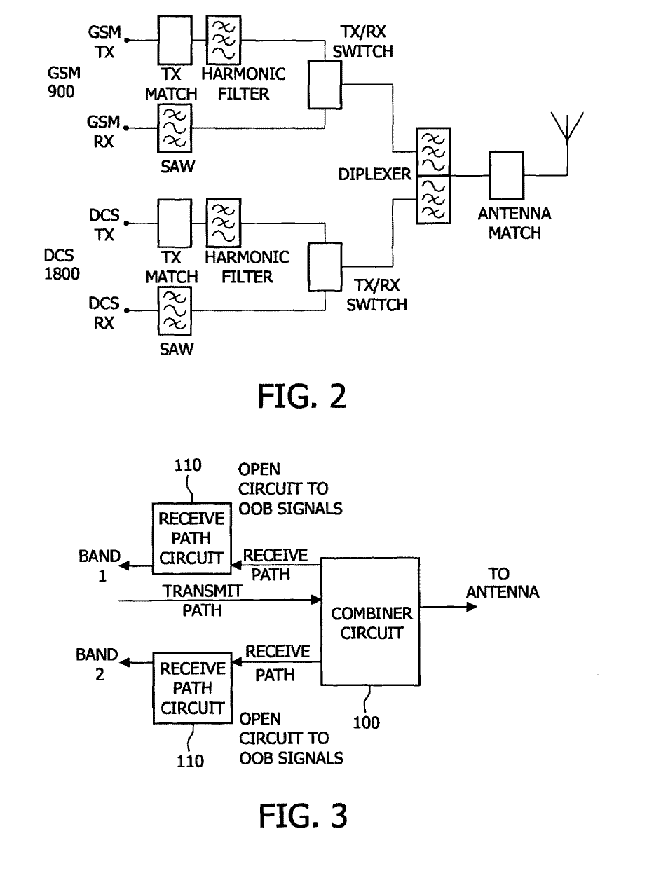

FIGS. 1 and 2 show known arrangements,

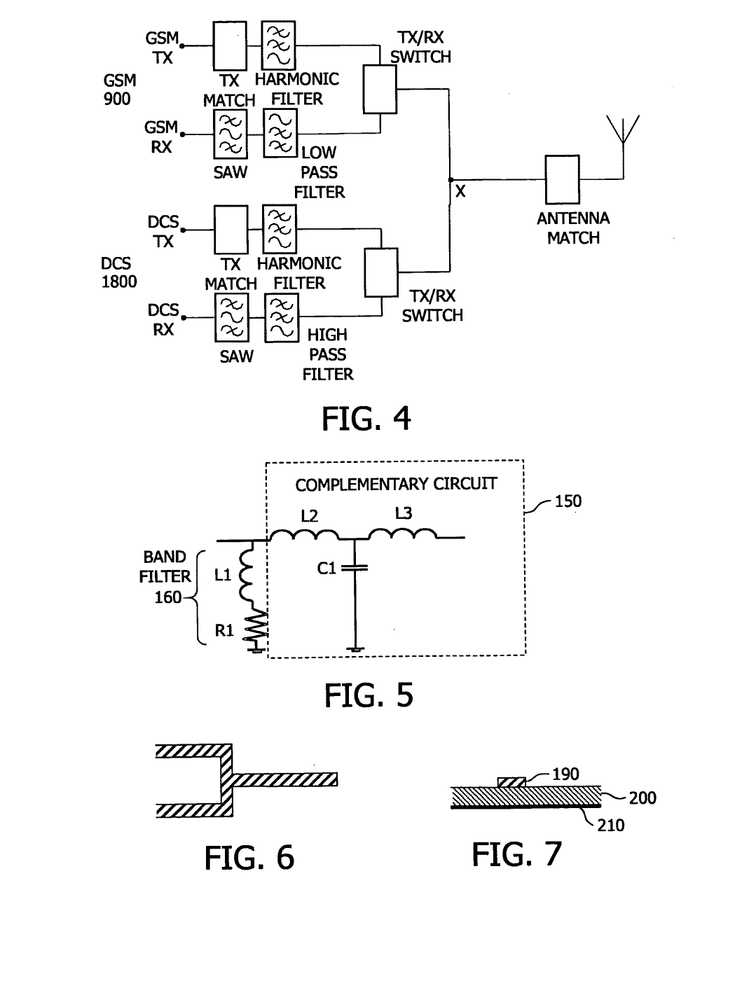

FIGS. 3 and 4 show embodiments of the invention,

FIG. 5 shows an example of a receive path circuit

FIGS. 6 and 7 show an example of a combiner circuit,

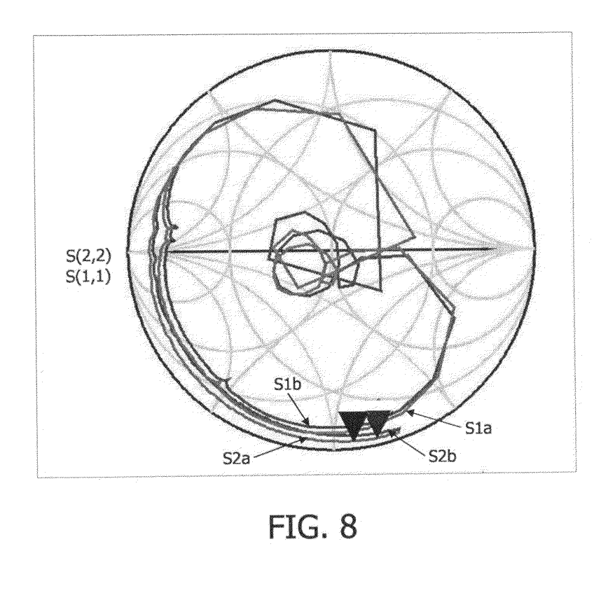

FIG. 8 shows a Smith chart for the receive path circuit,

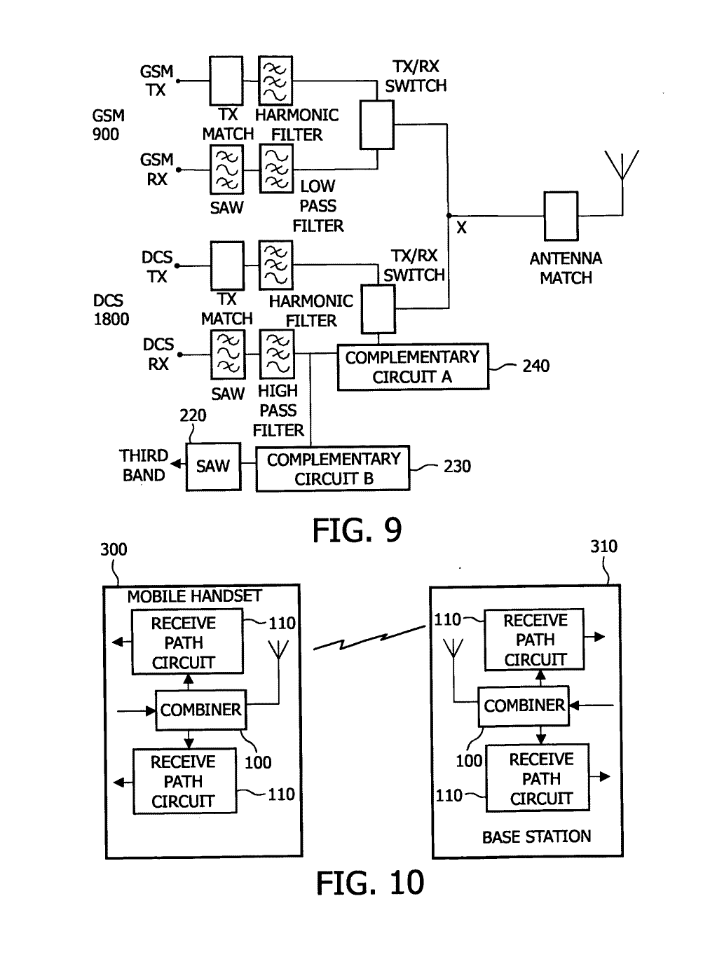

FIG. 9 shows an embodiment with a third band, and

FIG. 10 shows an embodiment of a base station and mobile device.

By way of introduction to the embodiments, a known wireless terminal is described with reference to FIG. 1. The embodiments can use many of the parts shown in this figure. The wireless terminal comprises a planar inverted F (PIFA) antenna 10 having feeds 12 and 14 to which are connected a GSM transceiver which operates in a frequency band of 880 to 960 MHz and a DCS transceiver which operates in the frequency band 1710 to 1880 MHz, respectively. A ground pin 16 is provided between the feeds 12,14. As the architectures of the GSM and the DCS transceivers are generally the same the corresponding stages will be referenced with suffices A and B respectively and in the interests of brevity only the GSM transceiver will be described. The transmitter section of the GSM transceiver comprises a signal input terminal 18A coupled to an input signal processing stage 20A. The stage 20A is coupled to a modulator 22A which provides a modulated signal to a transmitter stage 24A which includes a frequency up-converter, power amplifier and any relevant filters. A common coupling stage 26A couples the transmitter stage to the antenna feed 12. The common coupling stages 26A and 26B will be described in greater detail below. The coupling stage 26A is also coupled to a receiver section 28A of the GSM transceiver to the feed 10.

The receiver section 28A includes a low noise amplifier, a frequency down-converter and filters. An output of the receiver section 28A is demodulated in a demodulator 30A and its output is applied to a signal processing stage 32A which provides an output signal on a terminal 34A. The operation of both of the transceivers is controlled by a processor 36.

The PIFA incorporates a low valued shunt inductance across each feed. This inductance is tuned by shunt capacitors 46A, 46B on each feed by resonating with it at the resonant frequency of the antenna. Since the feeds are independent, each capacitance can be independently optimised, resulting in more wide band performance for both bands with no compromise required between the two bands. In order to prevent energy from being transferred between the two feeds 12,14, the antenna is co-designed with the RF front end by the provision of the common coupling stages 26A, 26B. The architectures of coupling stages 26A, 26B, are the same apart from one difference although the component values are selected for the particular frequencies of use and where appropriate the same reference numerals with the suffix A or B have been used to indicate corresponding components in the coupling stages 26A and 26B, respectively.

For convenience the coupling stage 26A will be described and the reference numerals of the corresponding components in the coupling stage 26B will be shown in parentheses. The output of the transmitting stage 24A (24B) is coupled to the anode of a low loss PIN diode D1 (D3), the cathode of which is coupled to one end of a series inductance 48A (48B). The other end of the inductance 48A (48B) is coupled to the feed 12 (14), to the shunt capacitor 46A (46B) and to one end of a quarter wavelength (A/4) transmission line 50A(50B). The other end of the transmission line 50A(50B) is coupled to the anode of a low loss PIN diode D2 (D4), the cathode of which is coupled to ground, and to an input of a band pass filter 52A (52B). The filters 52A, 52B may comprise SAW filters. The output of the filter 52A (52B) is coupled to the input of the receiver section 28A (28B).

If the filter 52B is implemented as a SAW filter, a RF resonant trap circuit 54 is provided in the signal path from the other end of the transmission line 50B to the input of the band pass filter 52B. The trap circuit comprises a series capacitor 56 and a shunt inductance 58 which is coupled to ground by way of a capacitor 60. The value of the capacitor 60 is selected to tune the inductance 58 so that the voltage at the input to the filter 52B is reduced. Typically such SAW filters can handle in-band signals of up to a power of 13 dBm. However for out-of-band signals a higher power can be delivered to such a filter which is useful as a GSM signal can have a power of up to 30 dBm. In an alternative implementation BAW (Bulk Acoustic Wave) filters may be considered as they exhibit the same out-of-band impedance characteristics to resonant SAW devices and also they do not suffer from the power handling restrictions which apply to SAW filters. The switching of the PIN diodes D1 to D4 is controlled by the processor 36.

FIG. 2 shows another known arrangement with a diplexer for coupling the paths of different bands. Two bands are used, at 900 and 1800 Mhz in this case. A receive and transmit path are shown for each band, not shown are IF and baseband processing circuits which could be as described in FIG. 1 for example. A band pass filter in the form of a SAW filter is shown in each receive path. Each transmit path has a transmitter match circuit, and a harmonic filter. A switch is used to couple the transmit and receive paths of each band. The switch for each band has a path to the diplexer, and the diplexer has a single path to the antenna via an antenna matching circuit. In this case, the diplexer typically causes a loss of approximately 0.5-0.7 dB in a 50 ohm system—more than this when a typical antenna is used. This is particularly undesirable in transmit mode, since battery power is lost.

FIG. 3 shows a first embodiment. In this case, the RF circuit has a receive path for each of two bands (more could be added) and a transmit path for at least one of the bands. A combiner circuit combines the paths to feed a single input output path to the antenna. The combiner need not cut off the receiver paths when they are not being used, since each receive path is provided with a receive path circuit which appears open circuit to out of band signals. Other parts of the transmit and receive circuitry such as power amplifiers are not shown. The circuit can be applied as an RF front end to a transceiver for a mobile handset as shown in FIG. 1.

FIG. 4 shows another embodiment with similar features to FIG. 2. Compared to FIG. 2, the RF front-end is modified so that the high pass and low pass sides of the diplexer are moved into the RX signal paths, so this can be called a distributed diplexer. When GSM is transmitting, DCS is switched to receive and visa-versa. Hence, the distributed diplexer ensures that the transmit signal is not lost in the receive path by presenting a reflective impedance (normally an open circuit) at point X. The high pass and low pass filters are effectively examples of the receive path circuit of FIG. 3. The switches and the junction at point X are effectively examples of the combiner circuit of is FIG. 3.

The diplexing action in the receive path can be further enhanced by utilising the out-of-band performance of the SAW filters (also ceramic and BAW equivalents). This will help to minimise the loss in the receive part of the circuit. In this case, the combination of the band filter (SAW filter) and the high pass or low pass filter of the distributed diplexer can be regarded as an example of the receive path circuit. It can improve the quality of the open circuit and thus help to reduce any transmission power loss caused by imperfection in the open circuit (since BAW and SAW devices are more highly reflective than filters fabricated from discrete components). Not shown are IF and baseband processing circuits which could be as described in FIG. 1 for example.

FIG. 5 shows an example of a band filter 160 and a complementary circuit 150. They can be used in the receive path circuit of FIG. 3, or as the SAW and high pass filter in FIG. 4 or in other embodiments. The band filter 160 can be a component or components represented as an inductor L1 in series with a resistor R1 to ground. The complementary component is arranged to have a characteristic which combines with the band filter to provide the desired characteristic of appearing open circuit to out of band signals, in particular the out of band signals that can be expected from other channels. The complementary circuit in this case is represented by a pair of inductors L2 and L3 with a capacitor C1 coupling a node between the inductors to ground. Other configurations can be conceived to achieve a similar effect. Further stages of the same arrangement can be added. The configuration can use conventional L/C or π type circuits, or can be implemented by a transmission line of suitable dimensions for example. If the band filter shows a capacitive characteristic, then the complementary circuit can be made inductive, e.g. by exchanging the positions of capacitors and inductors, following established principles.

FIGS. 6 and 7 show an example of a combiner circuit having a fixed bidirectional one-in multiple-out junction to couple together paths of two or more of the bands. FIG. 6 shows a plan view of a microstrip transmission line having a known configuration to achieve this. FIG. 7 shows a side view of the line 190, arranged on top of a dielectric layer 200, on top of a conductive layer 210.

FIG. 8 shows a Smith chart of an example of a SAW filter, in this case the frequency response of a commercial DCS SAW—the SAWTek 855860w—is shown in FIG. 8. This device is highly reflective (in this case capacitive) at GSM as shown in FIG. 8. This is typical of resonant SAW filters. Two lines are represented on the chart, indicating a response seen from either side of the device, over a range of frequencies between 800 Mhz and 3 GHz. The black triangles indicate impedances at frequencies of interest. The complementary circuit would need to have a response arranged to move either triangle to a point near the right hand end of the centre line of the chart. The open circuit need not be a perfect open circuit, in practice the closer it is the less transmit power is lost. It should be close enough that the power loss is less than the losses of the conventional diplexer in the transmit path. The points of interest are as follows for this example of a SAW filter:

s1b: 880 Mhz, S(1,1)=01946/−76,232, impedance=Z0*(0.073−j1.228)

s1b: 960 Mhz, S(1,1)=0.938/−82.993, impedance=Z0*(0.073−j1.228)

s2a: 880 Mhz, S(1,1)=0.966/−77.116, impedance=Z0*(0.044−j1.254)

s2b: 960 Mhz, S(1,1)=0.962/−84.003, impedance=Z0*(0.043−j1.110)

The power handling capabilities of SAW filters are determined by acoustic resonance and electrical breakdown. The acoustic resonance leads to degradation of the SAW fingers. The electrical breakdown can occur due to high electric fields in very thin layers of dielectric. When the device is operated out-of-band only the second of these factors is significant (there can be some bulk acoustic modes above resonance but these are thought to have a minor effect on the power handling capabilities of the device). This allows a higher power to be delivered to the device when used out-of-band. The exact power level depends on the device. Should the power out-of-band voltage across the device be too high a resonant trap can be provided to bring it within acceptable limits. BAW filters can be used in exactly the same way as their SAW counterparts, since they exhibit similar out-of-band impedance characteristics to resonant SAW devices. However, BAW filters do not suffer from the power handling restrictions that apply to SAW filters. The complementary circuit for this type of SAW would need to show an inductive characteristic to bring the out of band (OOB) characteristic to an open circuit, represented by a value near the right hand side of the centre line of the Smith chart.

FIG. 9 shows a circuit similar to that of FIG. 4, but adding a path for receiving a third band such as a GPS signal. A junction similar to that of FIGS. 6 and 7 can be provided to join this path to the receive path of the DCS band. This is an example of the second transmission line junction. The third band has its own band filter such as a SAW filter 220. The complementary circuit is divided into two parts, A (240) and B (230). Part A is in the combined receive path before the combiner. Part B is after the combiner. As before the purpose of the complementary circuit is to make each receive path appear open circuit to out of band signals.

FIG. 10 shows examples applied to a mobile handset 300 and base station 310. Each has RF circuits including the combiner 100 and receive path circuits 110, as shown above in FIG. 3. As in FIG. 3, each RF circuit has a receive path for each of two bands (more could be added) and a transmit path for at least one of the bands. The combiner circuit combines the paths to feed a single input output path to the antenna. The combiner need not cut off the receive paths when they are not being used, since each receive path is provided with a receive path circuit which appears open circuit to out of band signals. Other parts of the transmit and receive circuitry such as power amplifiers, filters and antenna match circuitry are not shown.

As has been described above, a multi-band RF circuit has receive paths for two or more bands, and transmit paths, a bidirectional one-in multiple-out transmission line junction for combining the paths for coupling to an antenna. A switch combines transmit and receive paths, and a receive path circuit is arranged to pass signals of its band, and appear open circuit to signals of the other bands. This means the combiner no longer needs to cut off the receive paths when they are not used. This can reduce components and thus reduce losses in the transmit paths for longer battery life or greater transmit range. A band filter (SAW) and a complementary circuit can achieve the open circuit. The bands can include GSM and GPS bands, the circuits can be used in tri band mobile handsets and handsets for future 3G bands, or base stations.

Other variations and examples within the scope of the claims will be apparent to those skilled in the art.

1. A multi-band RF circuit having receive paths for two or more bands, and transmit paths for at least one of the bands, a combiner circuit for combining the paths for coupling to an antenna, and a receive path circuit in each of the receive paths for each band before the combiner circuit, arranged to pass signals of its band, and appear open circuit to signals of the other bands.)

2. The circuit of claim 1, the combiner circuit having a fixed bidirectional one-in multiple-out junction to couple together paths of two or more of the bands.)

3. The circuit of claim 1, the receive path circuit having a band filter (160) and a complementary circuit to complement the out of band impedance of the band filter to achieve the open circuit.

4. The circuit of claim 3, the combiner circuit comprising a transmission line junction for combining paths of different bands.

5. The circuit of claim 1 having a switch to combine transmit and receive paths for each band.

6. The circuit of claim 1 when dependent on claim 3, each complementary circuit comprising passive components to maintain a characteristic impedance to in band signals, and to contribute to the open circuit to out of band signals.

7. The circuit of claim 1, the band filter comprising an acoustic wave filter.

8. The circuit of claim 1 having paths for two bands and having two receive paths.

9. The circuit of claim 8 having paths for a third band and arranged to share a transmit path with another of the bands and having a separate receive path.

10. The circuit of claim 9 having a second transmission line junction for combining the receive path of the third band with the receive path of another of the bands before the combiner circuit.

11. Apparatus having the multi band RF circuit of claim 1, coupled to a single input antenna matching circuit and an antenna.

12. A mobile battery powered device having the apparatus of claim 11.

13. A fixed base station having the apparatus of claim 11.
